(19) United States
(12) Patent Application Publication
(10) Pub. No.: US 2023/0035902 A1
(43) Pub. Date: Feb. 2, 2023

(54) DEVICE AND METHOD FOR TESTING FRACTURE TOUGHNESS OF SOLID-ICE INTERFACE ON SURFACE OF COATING MATERIAL IN LARGE-SCALE FREEZING STATUS

(71) Applicant: NANJING UNIVERSITY OF AERONAUTICS AND ASTRONAUTICS, Nanjing, Jiangsu (CN)

(72) Inventors: Yizhou SHEN, Nanjing, Jiangsu (CN); Jie TAO, Nanjing, Jiangsu (CN); Chaojiao ZENG, Nanjing, Jiangsu (CN); Xinyu XIE, Nanjing, Jiangsu (CN)

(21) Appl. No.: 17/790,560

(22) PCT Filed: Apr. 17, 2020
(86) PCT No.: PCT/CN2020/085278

§ 371 Date: Jul. 1, 2022

(30) Foreign Application Priority Data
Apr. 3, 2020 (CN) 202010259448.0

(51) Int. Cl. G01N 19/04

(52) U.S. Cl. CPC G01N 19/04

(57) ABSTRACT

A device and method for testing fracture toughness of a solid-ice interface on a surface of coating material in a large-scale freezing status are provided. The method uses the principle of single-cantilever beam loading, and utilizes the bending stress of a metal substrate to induce the generation and extension of micro-cracks at the solid-ice interface, which are intended to observe the fracture behavior at the interface between the surface of a coating material with metal as a substrate and the ice layer, so as to obtain the fracture toughness at the interface between the ice layer and the surface of the substrate.

### CROSS REFERENCE TO RELATED APPLICATIONS

This application claims priority to International Patent Application No. PCT/CN2020/085278, filed on Apr. 17, 2020, which claims priority of the Chinese Patent Application No. 202010259448.0, filed on Apr. 3, 2020. The entire disclosures of the above applications are incorporated herein by reference.

### TECHNICAL FIELD

The present disclosure relates to the technical field of material surface engineering, and relates to a testing method for testing and evaluating the fracture toughness at a joint between a surface of a large-scale engineering application material and an ice layer, and in particular, to a device and method for testing fracture toughness of a solid-ice interface on a surface of coating material in a large-scale freezing status.

### BACKGROUND

With the continuous innovation and development of industry technologies, common engineering application materials can no longer meet the requirements of existing service environments, and it is urgent to develop new materials and new technologies for various extremely demanding service environments. At the same time, researchers from all over the world are interested in functional application type materials for a low-temperature and high-humidity service environment, and achieve certain research progress, especially in terms of reducing the adhesion of ice layers from a material surface.

Due to the large difference between the elastic modulus of the ice layer and the substrate material, micro-cracks are easily formed at the solid-ice interface. Currently, the anti-icing performance of materials is commonly characterized by the adhesive strength of the ice layer. Common methods for evaluating the magnitude of the adhesive strength of the ice layer are, for example, transversal shear test, vertical shear test, and centrifugal test and the like, but these methods are mostly used for deicing test in a small-scale range. However, there are few studies on the low ice adhesion surface in a large scale of several square centimeters or even more freezing status, especially there are few reports to characterize the adhesion of a large-scale ice layer from the surface of substrate materials in terms of the fracture toughness of solid-ice interface.

However, along with the continuous development of current anti-icing technologies and the continuous improvement of demand for large-scale anti-icing surfaces, it is of great significance to design a testing method for evaluating the fracture toughness of a solid-ice interface in a large-scale freezing status for industrial application and development of anti-icing surfaces.

### SUMMARY

In order to overcome the shortcomings of the prior art, the present disclosure provides a device and method for testing fracture toughness of a solid-ice interface on a surface of coating material in a large-scale freezing status, which is intended to observe the fracture behavior at the interface between the surface of the metal-substrate coating material and the ice layer, so as to obtain the fracture toughness of the interface between the ice layer and the surface of the substrate, and achieve the objective of objectively evaluating the fracture toughness of a solid-ice interface in a large-scale freezing status, which has great significance for industrial application and development of an anti-icing surface.

The present disclosure provides a device for testing fracture toughness of a solid-ice interface on a surface of coating material in a large-scale freezing status, which includes a force gauge, a laboratory test bench, a clamping apparatus, and a high-speed microscopic camera. The laboratory test bench is configured for placing a frozen coating sample horizontally, the clamping apparatus is configured for fixing the frozen coating sample, the force gauge is configured for connecting to the frozen coating sample, and the high-speed microscopic camera is configured for observing fracture behavior between a coated surface of the frozen coating sample and an ice layer.

The present disclosure also provides a method for testing fracture toughness of a solid-ice interface on a surface of coating material in a large-scale freezing status, wherein the method applies the device for testing fracture toughness of a solid-ice interface on a surface of coating material in a large-scale freezing status to test the fracture toughness of the solid-ice interface on a surface of coating material in a large-scale freezing status. The method specifically includes the following steps:

step 1), placing a frozen coating sample on a laboratory test bench, and leveling the device by using a level gauge, wherein the frozen coating sample has a metal substrate;

step 2), fixing the frozen coating sample by a clamping apparatus, wherein one end of the frozen coating sample is clamped, and the other end of the frozen coating sample is movable in a vertical direction; the other end of the frozen coating sample is connected to the force gauge;

step 3), applying an acting force perpendicular to a beam direction to the other end of the frozen coating sample, such that, the frozen coating sample is intended to be de-adhered under the acting force, continuously applying the acting force, observing and recording extension process of micro-cracks of the solid-ice interface in real time by a high-speed microscopic camera, until an ice layer falls off, and recording a value P displayed by the force gauge at the time the ice layer falls off;

step 4), analyzing images obtained by the high-speed microscopic camera to obtain extension velocity Vᵢ of the micro-cracks on a surface of the frozen coating sample;

step 5), substituting the extension velocity Vᵢ of the micro-cracks on the surface of the frozen coating sample and the value P displayed by the force gauge when the ice layer falls off into a formula

$${G}_{IC} = \frac{ζ {P}^{2} {a}^{2} Δ}{2 BEI}$$

to obtain the fracture toughness of the solid-ice interface; wherein P is a pulling force applied to the metal substrate of the frozen coating sample when the micro-cracks become unstable to extend, a is length of the micro-cracks, Δ is an error of the clamping apparatus, and ζ is a coefficient value; and

$$ζ = \frac{{\sum }_{i = 1}^{k} {lgV}_{i} lg \frac{{V}_{i}^{3}}{3 EI} - \frac{1}{k} ( {\sum }_{i = 1}^{k} {V}_{i} ) ( {\sum }_{i = 1}^{k} lg \frac{{V}_{i}^{3}}{3 EI} )}{{\sum }_{i = 1}^{k} {( lg \frac{{V}_{i}^{3}}{3 EI} )}^{2} - \frac{1}{k} {( {\sum }_{i = 1}^{k} {lgV}_{i} )}^{2}} ,$$

wherein k is a number of measurement points of an individual frozen coating sample, Vᵢ is the extension velocity of the micro-cracks on the surface of the frozen coating sample during i-th measurement, B is width of the frozen coating sample, and EI is bending stiffness of material; and

EI=EₘIₘ+E_{c}I_{c}+EₙIₙ, subscripts “m”, “c” and “n” respectively represent the metal substrate, a coating and an ice layer, wherein E is the elastic modulus, I is a moment of inertia,

$$I = \frac{{Bh}^{3}}{12} ,$$

and h is a thickness of layer.

In some embodiments, in step 1), a thickness of a low ice adhesion coating of the frozen coating sample is 2˜100 μm, and a thickness of the ice layer is 0.5˜10 cm; the metal substrate is rectangular-shaped, and the metal comprises aluminum and stainless steel.

In some embodiments, in step 1), unfrozen areas are reserved at two ends of the frozen coating sample, and a clamping position of the clamping apparatus is at unfrozen end areas of the coating sample surface.

In some embodiments, in step 1), the level gauge is a bubble level gauge with a precision of 1 degree.

In some embodiments, the clamping apparatus is a C-shaped clamp.

In some embodiments, the high-speed microscopic camera is a CCD camera.

In some embodiments, the method for testing uses a principle of single-cantilever beam loading, and uses a bending stress of the metal substrate to induce the generation and extension of micro-cracks at the solid-ice interface.

The present disclosure is advantageous in that:

1. It is provided a method for testing fracture toughness of a solid-ice interface on a surface of coating material in a large-scale freezing status by the present disclosure. By designing a single-cantilever beam experiment, a bending stress of the metal substrate is used to induce the generation of micro-cracks at the solid-ice interface, and recording and observing the extension process of cracks at the solid-ice interface by the high-speed microscopic camera, so as to obtain the extension velocity of the micro-cracks, and thus the fracture toughness of the solid-ice interface is calculated from the formulas.

2. It is provided a method for testing fracture toughness of a solid-ice interface on a surface of coating material in a large-scale freezing status by the present disclosure, which can accurately evaluate the anti-icing performance of a coating material of a large-scale member, is easy to operate and convenient, and has great research significance for industrial application and development of an anti-icing surface.

3. It is provided a device for testing fracture toughness of a solid-ice interface on a surface of coating material in a large-scale freezing status by the present disclosure, which is simple in structure, is ingenious in design, and is easy to operate, and has a good working effect.

### BRIEF DESCRIPTION OF THE DRAWINGS

FIG. 1 is a structural schematic diagram of a device for testing fracture toughness of a solid-ice interface on a surface of coating material in a large-scale freezing status according to a first embodiment of the present disclosure;

FIG. 2 is a schematic flow chart of a method for testing fracture toughness of a solid-ice interface on a surface of coating material in a large-scale freezing status according to a first embodiment of the present disclosure;

FIG. 3 is a schematic diagram of an experimental procedure of a method for testing fracture toughness of a solid-ice interface on a surface of coating material in a large-scale freezing status according to a first embodiment of the present disclosure;

FIG. 4 is a structural schematic diagram of a frozen coating sample in the method for testing fracture toughness of a solid-ice interface on a surface of coating material in a large-scale freezing status according to a first embodiment of the present disclosure.

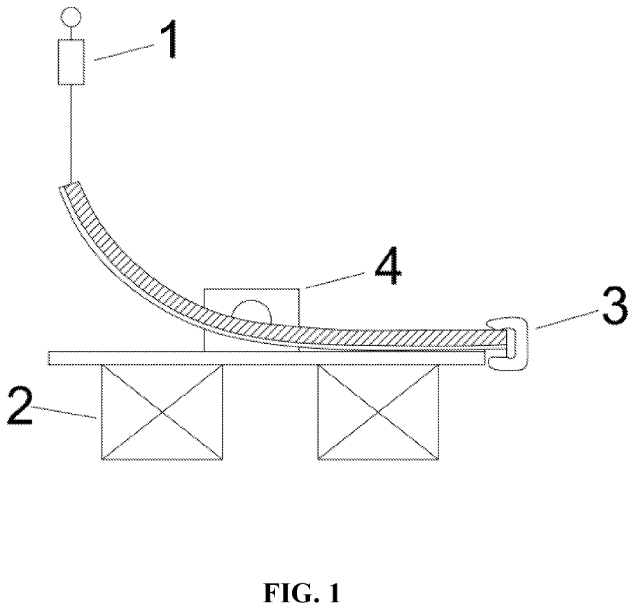

In FIGS. 1 to 4, the reference numerals in the figures are: 1—force gauge, 2—laboratory test bench, 3—clamping apparatus, 4—high-speed microscopic camera.

### DETAILED DESCRIPTION OF THE EMBODIMENTS

To make the objectives, technical solutions, and advantages of the embodiments of the present disclosure more obvious, the following clearly and completely describes the technical solutions in the embodiments of the present disclosure with reference to FIGS. 1 to 4 in the embodiments of the present disclosure. Apparently, the described embodiments are a part rather than all of the embodiments of the present disclosure. All other embodiments obtained by persons of ordinary skill in the art based on the embodiments of the present disclosure without creative labors shall fall within the protection scope of the present disclosure.

### First Example

As shown in FIG. 1, a device for testing fracture toughness of a solid-ice interface on a surface of coating material in a large-scale freezing status includes: a force gauge 1, a laboratory test bench 2, a clamping apparatus 3, and a high-speed microscopic camera 4. The laboratory test bench 2 is configured for placing a frozen coating sample horizontally. The clamping apparatus 3 is configured for fixing the frozen coating sample. The force gauge 1 is configured for connecting to the frozen coating sample. The high-speed microscopic camera 4 is configured for observing the fracture behavior between the surface of the coating sample and an ice layer.

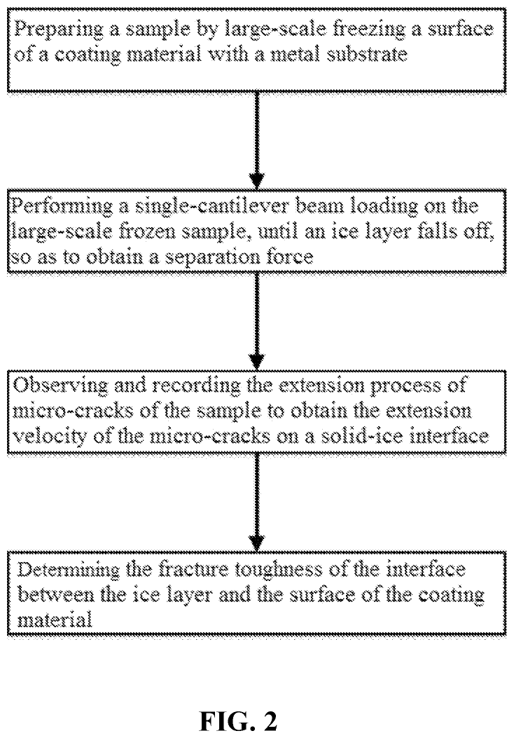

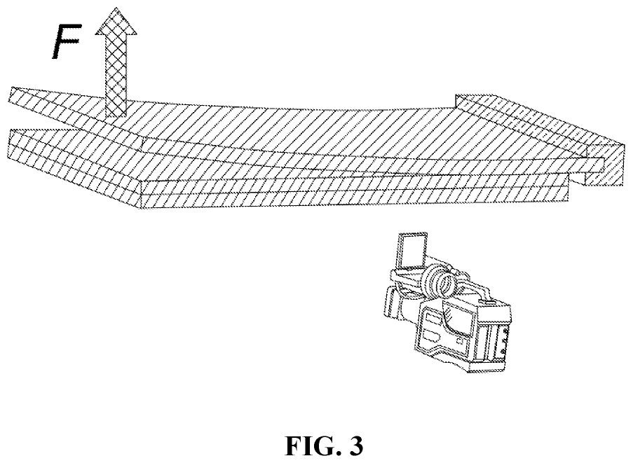

As shown in FIGS. 2 and 3, a method for testing fracture toughness of a solid-ice interface on a surface of coating material in a large-scale freezing status is performed by the device for testing fracture toughness of a solid-ice interface on a surface of coating material in a large-scale freezing status, and includes the following steps:

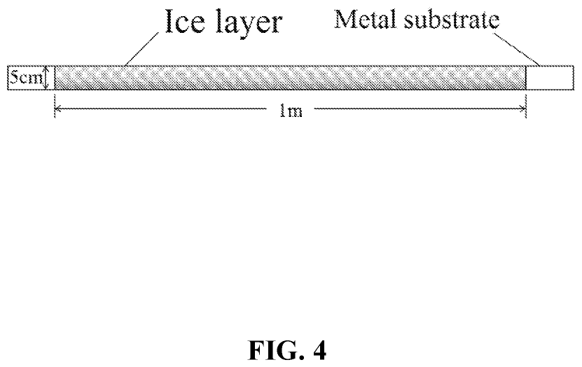

step 1), an aluminum substrate having a size of 1.2 m×5 cm×0.8 cm is used, after being grinded, successively being washed with deionized water and absolute ethanol, and being dried to obtain a pretreated aluminum substrate; parts A and B of the Dow Corning Sylgard 184 are mixed at a weight ratio of 10:1, and stirred vigorously for 10 minutes to obtain a polymeric precursor solution, the mixture of Span 80 and Tween 80 with a weight ratio of 3:1 is stirred vigorously for 5 minutes as a porogen, and the polymeric precursor solution is mixed with the porogen at a weight ratio of 10:3, stirred vigorously for 10 minutes, and then shaken and degassed for 15 min, so as to obtain a mixed emulsion. The described mixed emulsion is sprayed by a pneumatic automatic spray gun onto a surface of the pretreated aluminum substrate, in which the spraying parameters of the pneumatic spray gun are: a pressure of 0.24 MPa, the spraying flow rate of 4 mL·min⁻¹; after curing overnight, the pretreated aluminum substrate is placed in a mixed solution of ethanol and water at a weight ratio of 1:1 for 6 h, so as to remove the porogen, and after drying, a coating sample is obtained. The thickness of the coating is 50 μm, and then an end cover is fixed to the surface of the coating sample with an available adhesive tape; a distance of 10 cm is reserved on each of the left and right ends for clamping the sample. Moreover, it is ensured that the adhesive length of the ice layer is 1 m; and the deionized water is poured into the surface of the coating sample and then placed in a refrigerator at −15° C. for 10 h so as to ensure that the surface of the sample is completely frozen, in which the ice layer has a thickness of 1 cm, see FIG. 4.

step 2), the frozen coating sample described above is placed on the laboratory test bench 2 and the entire system was leveled by using a level gauge with a precision of 1 degree.

step 3), the coating sample is fixed by the clamping apparatus 3, wherein one end of the coating sample is clamped, and the other end of the coating sample is movable in the vertical direction; a free end of the coating sample is connected to the force gauge 1; the clamping apparatus 3 is a C-shaped clamp;

step 4), an acting force perpendicular to the beam direction is applied to the free end of the coating sample, such that, the coating sample is intended to be de-adhered under the acting force; the acting force continues to be applied, and the extension process of the micro-cracks is observed and recorded in real time by using the high-speed microscopic camera 4 until the ice layer falls off, the value P displayed by the force gauge at the time the ice layer falls off is recorded; and

according to a calculation formula of the bending stiffness EI=EₘIₘ+E_{c}I_{c}+EₙIₙ, where is the bending stiffness of the metal substrate, E_{c}I_{c} is the bending stiffness of the coating material, and EₙIₙ is the bending stiffness of the ice layer, where E is the elastic modulus, I is the moment of inertia,

$$I = \frac{{Bh}^{3}}{12} ,$$

and h is the thickness of the layer,

This method for testing applies the principle of single-cantilever beam loading, and utilizes the bending stress of the metal substrate to induce the generation and extension of micro-cracks at the solid-ice interface.

step 5), the images obtained by the high-speed microscopic camera 4 are analyzed, so as to obtain the extension velocity Vᵢ of the micro-cracks on the surface of the coating sample; the high-speed microscopic camera 4 is a CCD camera

step 6, the extension velocity Vi of the micro-cracks on the surface of the coating sample and the value P displayed by the force gauge when the ice layer falls off are substituted into a formula

$${G}_{IC} = \frac{ζ {P}^{2} {a}^{2} Δ}{2 BEI}$$

to obtain the fracture toughness of the solid-ice interface; where P is a pulling force applied to the metal substrate of the frozen coating sample when the micro-cracks become unstable to extend, a is length of the micro-cracks, Δ is an error of the clamping apparatus, and ζ is a coefficient value; and

$$ζ = \frac{{\sum }_{i = 1}^{k} {lgV}_{i} lg \frac{{V}_{i}^{3}}{3 EI} - \frac{1}{k} ( {\sum }_{i = 1}^{k} {V}_{i} ) ( {\sum }_{i = 1}^{k} lg \frac{{V}_{i}^{3}}{3 EI} )}{{\sum }_{i = 1}^{k} {( lg \frac{{V}_{i}^{3}}{3 EI} )}^{2} - \frac{1}{k} {( {\sum }_{i = 1}^{k} {lgV}_{i} )}^{2}} ,$$

wherein k is the number of measurement points of an individual frozen coating sample, Vᵢ is the extension velocity of the micro-cracks on the surface of the frozen coating sample during i-th measurement, B is width of the frozen coating sample, and EI is bending stiffness of material.

It should be understood that the described specific embodiments are only used to explain the present disclosure, but are not used to limit the present disclosure. The obvious variations and modifications made by the spirit of the present disclosure are still within the protection scope of the present disclosure.

1-9. (canceled)

10. A device for testing fracture toughness of a solid-ice interface on a surface of coating material in a large-scale freezing status, comprising:
a force gauge;
a laboratory test bench;
a clamping apparatus; and
a high-speed microscopic camera;
wherein:
the laboratory test bench is configured for placing a frozen coating sample horizontally,
the clamping apparatus is configured for fixing the frozen coating sample,
the force gauge is configured for connecting to the frozen coating sample, and
the high-speed microscopic camera is configured for observing fracture behavior between a surface of the frozen coating sample and an ice layer.

11. A method for testing fracture toughness of a solid-ice interface on a surface of coating material in a large-scale freezing status, wherein the method applies the device for testing fracture toughness of a solid-ice interface on a surface of coating material in a large-scale freezing status according to claim 10 to test the fracture toughness of the solid-ice interface on a surface of coating material in a large-scale freezing status.

12. The method for testing fracture toughness of a solid-ice interface on a surface of coating material in a large-scale freezing status according to claim 11, comprising:
step 1) placing a frozen coating sample on a laboratory test bench, and leveling the device by using a level gauge, wherein the frozen coating sample has a metal substrate;
step 2) fixing the frozen coating sample by a clamping apparatus, wherein one end of the frozen coating sample is clamped, and another end of the frozen coating sample is movable in a vertical direction; the other end of the frozen coating sample is connected to the force gauge;
step 3) applying an acting force perpendicular to a beam direction to the other end of the frozen coating sample, such that, the frozen coating sample is intended to be de-adhered under the acting force, continuously applying the acting force, observing and recording extension process of micro-cracks of the solid-ice interface in real time by a high-speed microscopic camera, until an ice layer falls off, and recording a value P displayed by the force gauge at the time the ice layer falls off;
step 4) analyzing images obtained by the high-speed microscopic camera to obtain extension velocity Vᵢ of the micro-cracks on a surface of the frozen coating sample;
step 5) substituting the extension velocity Vᵢ of the micro-cracks on the surface of the frozen coating sample and the value P displayed by the force gauge when the ice layer falls off into a formula
$${G}_{IC} = \frac{ζ {P}^{2} {a}^{2} Δ}{2 BEI}$$
to obtain the fracture toughness of the solid-ice interface; wherein P is a pulling force applied to the metal substrate of the frozen coating sample when the micro-cracks become unstable to extend, a is length of the micro-cracks, Δ is an error of the clamping apparatus, and ζ is a coefficient value; and
$$ζ = \frac{{\sum }_{i = 1}^{k} {lgV}_{i} lg \frac{{V}_{i}^{3}}{3 EI} - \frac{1}{k} ( {\sum }_{i = 1}^{k} {V}_{i} ) ( {\sum }_{i = 1}^{k} lg \frac{{V}_{i}^{3}}{3 EI} )}{{\sum }_{i = 1}^{k} {( lg \frac{{V}_{i}^{3}}{3 EI} )}^{2} - \frac{1}{k} {( {\sum }_{i = 1}^{k} {lgV}_{i} )}^{2}} ,$$
wherein k is a number of measurement points of an individual frozen coating sample, Vᵢ is the extension velocity of the micro-cracks on the surface of the frozen coating sample during i-th measurement, B is width of the frozen coating sample, and EI is bending stiffness of material; and
EI=EₘIₘ+E_{c}I_{c}+EₙIₙ, subscripts “m”, “c” and “n” respectively represent the metal substrate, a coating and an ice layer, wherein E is elastic modulus, I is a moment of inertia,
$$I = \frac{{Bh}^{3}}{12} ,$$
and h is a thickness of layer.

13. The method for testing fracture toughness of a solid-ice interface on a surface of coating material in a large-scale freezing status according to claim 12, wherein in the step 1), a thickness of a low ice adhesion coating of the frozen coating sample is 2˜100 μm, and a thickness of the ice layer is 0.5˜10 cm; the metal substrate is rectangular-shaped, and the metal comprises aluminum and stainless steel.

14. The method for testing fracture toughness of a solid-ice interface on a surface of coating material in a large-scale freezing status according to claim 12, wherein in the step 1), unfrozen areas are reserved at two ends of the frozen coating sample, and a clamping position of the clamping apparatus is at unfrozen end areas of the coating sample surface.

15. The method for testing fracture toughness of a solid-ice interface on a surface of coating material in a large-scale freezing status according to claim 12, wherein in the step 1), the level gauge is a bubble level gauge with a precision of 1 degree.

16. The method for testing fracture toughness of a solid-ice interface on a surface of coating material in a large-scale freezing status according to claim 12, wherein the clamping apparatus is a C-shaped clamp.

17. The method for testing fracture toughness of a solid-ice interface on a surface of coating material in a large-scale freezing status according to claim 12, wherein the high-speed microscopic camera is a CCD camera.

18. The method for testing fracture toughness of a solid-ice interface on a surface of coating material in a large-scale freezing status according to claim 12, wherein the method for testing uses a principle of single-cantilever beam loading, and utilizes a bending stress of the metal substrate to induce generation and extension of micro-cracks at the solid-ice interface.
